(19) United States
(12) Patent Application Publication
(10) Pub. No.: US 2006/0251422 A1
(43) Pub. Date: Nov. 9, 2006

(54) Power and energy scaling of fiber lasers by using compact divisional wavelength multiplexing (WDM) devices

(76) Inventor: Jian Liu, Sunnyvale, CA (US)

Correspondence Address: Bo-In Lin, 13445 Mandoli Drive, Los Altos Hills, CA, 94022, US

(21) Appl. No.: 11/418,672

(22) Filed: May 7, 2006

Related U.S. Application Data
(60) Provisional application No. 60/679,640, filed on May 6, 2005.
(60) Provisional application No. 60/679,642, filed on May 6, 2005.

(51) Int. Cl. H04J 14/02

(52) U.S. Cl. 398/79

(57) ABSTRACT

A fiber laser system includes a plurality of input ports for projecting a plurality of incident lasers each having a different wavelength to a wavelength divisional multiplexing (WDM) device for multiplexing a scaled portion for each of the incident lasers into a multiplexed and scaled output laser with a scaled output power. The fiber laser system further includes a collimator to collimate the plurality of incident lasers for projecting into the WDM device. An optical coupler optically coupled to the WDM device to combine the multiplexed output laser into an output laser with the scaled output power.

This Formal Application claims a Priority Date of May 6, 2005 benefit from two Provisional Patent Applications 60/679,640 and 60/679,642 filed by the same Applicant of this Application. The disclosures made in 60/679,640 and 60/679,642 are hereby incorporated by reference in this Patent Application.

### FIELD OF THE INVENTION

The present invention relates generally to apparatuses and methods for providing short-pulsed mode-locked fiber laser. More particularly, this invention relates to new configurations and methods for providing a nonlinear polarization pulse-shaping mode-locked fiber laser with improved and better controllable pulse shapes.

### BACKGROUND OF THE INVENTION

Even though current progress in the technologies of fiber laser has achieved a power level of tens of kilowatts in continuous wave (CW) operation and multiple-mJ in pulse operation, there are still technical difficulties and limitations in scaling the power/energy of the laser sources that hinder the usefulness of fiber lasers. The recent progresses made in the laser sources to achieve kilowatt power were disclosed by D. N. Payne, et al., in the publication “Kilowatt class single frequency fiber sources,” SPIE 5709, 133-146 (2005), and by A. Babushkin, et al., in “Multi-kilowatt peak power pulsed fiber laser with precise computer controlled pulse duration for material processing,” SPIE 5709, 98-109 (2005). An earlier disclosure was made by J Limpert, et al., in “Power and energy scaling of fiber laser systems based on Ytterbium doped large mode area fibers, ” SPIE proceedings 4974, 135-147 (2003). However, due to the intrinsic limitation in fiber core size and severe nonlinear effects such as self phase modulation (SPM), Stimulated Brillouin scattering (SBS), and stimulated Raman scattering (SRS), the power scaling is becoming an issue for fiber laser to continue its progress in competing conventional solid state approaches even though large mode area (LMA) or multi mode fibers are used. For example, the extractable energy for a LMA is limited to a few mJ for ten of ns pulse as that disclosed by J Limpert, et al., and tens of kW for CW operation. If the pulse width goes down, the energy extractable will be reduced accordingly. FIG. 1 gives an example of a 1 ns pulse for a 30 micrometers LMA fiber. A couple of mJ can be extracted for 1 ms pulse by using even a LMA fiber of 30 micrometers. It clearly indicates SRS plays a very serious role in high energy/power operation. For single frequency operation, the technical difficultiy of SBS becomes a major obstacle.

More specifically, the practical usefulness of the ultra-short high power lasers are often hindered by the pulse shapes distortions. Furthermore, such laser systems are often bulky, difficult for alignment maintenance, and also lack sufficient robustness. All these difficulties prevent practical applications of the ultra-short high power lasers. Historically, generation of mode-locked laser with the pulse width down to a femtosecond level is a difficult task due to limited resources of saturation absorbers and anomalous dispersions of fibers. Conventionally, short pulse mode locked fiber lasers operated at wavelengths below 1.3 μm present a particular challenge is that there is no simple all fiber based solution for dispersion compensation in this wavelength regime. (For wavelengths above 1.3 μm, several types of fibers exist exhibiting either normal or anomalous dispersion, so by splicing different lengths of fibers together one can obtain a cavity with an adjustable dispersion.) Therefore, previous researchers use bulk devices, such as grating pairs and prisms to provide an adjustable amount of dispersion for the cavity. Unfortunately these devices require the coupling of the fiber into a bulk device, which results in a laser that is highly sensitive to alignment and thus the environment

Several conventional techniques disclosed different semiconductor saturation absorbers to configure the ultra-short high power laser systems. However, such configurations often developed into bulky and less robust systems due to the implementations of free space optics. Such systems have been disclosed by S.N. Bagayev, S.V. Chepurov, V.M. Klementyev, S.A. Kuznetsov, V.S. Pivtsov, V.V. Pokasov, V.F. Zakharyash, A femtosecond self-mode-locked Ti:sapphire laser with high stability of pulserepetition frequency and its applications (Appl. Phys. B, 70, 375-378 (2000).), and Jones D.J., Diddams S.A., Ranka J.K., Stentz A., Windeler R.S., Hall J.L., Cundi® S.T., Carrierenvelope phase control of femtosecond mode-locked laser and direct opticalfrequency synthesis. (Science, vol. 288, pp. 635-639, 2000.). 70, 375-378 (2000).)

Subsequently, the stretched mode-locked fiber lasers are disclosed to further improve the generation of the short pulse high power lasers. However, even in the stretched mode locked fiber lasers, the free space optic components such as quarter wave retarder and splitters for collimating and coupling are implemented. Examples of these systems are described by John L. Hall, Jun Ye, Scott A. Diddams, Long-Sheng Ma, Steven T. Cundi®, and David J. Jones, in “Ultrasensitive Spectroscopy, the Ultrastable Lasers, the Ultrafast Lasers, and the Seriously Nonlinear Fiber: A New Alliance for Physics and Metrology” (IEEE JOURNAL OF QUANTUM ELECTRONICS, VOL. 37, NO. 12, DEC. 2001), and also by L. Hollberg, C. W. Oates, E. A. Curtis, E. N. Ivanov, S. A. Diddams, Th.Udem, H. G. Robinson, J. C. Bergquist, R. J. Rafac, W. M. Itano, R. E. Drullinger, and D. J. Wineland, in “Optical frequency standards and measurements” IEEE J. Quant. Electon. 37, 1502 (2001).

The limitations for practical application of such laser systems are even more pronounced due the pulse shape distortions when the pulse width is further reduced compounded with the requirement of high power fiber amplification. When the pulse width narrows down to femtosecond level and the peak power increases to over 10 kW, strong nonlinear effects such as self phase modulation (SPM) and XPM will cause more serious spectral and temporal broadening. These nonlinear effects and spectral and temporal broadening further causes a greater degree of distortions to the laser pulses. In order to more clearly understand the technical difficulties, please refer to FIG. 1. FIG. 1 shows a simulation analysis for the nano second (ns) pulses transmitted through a fiber amplifier. The functional relationship between the pulse energy as function of the fiber length provide a guidance of the pulse energy that can be extracted from the fiber amplifier/laser when different kinds of the nonlinear effects such as SPM, SRS, SBS and self focusing are considered. The technical difficulties cannot be easily resolved even though a large mode area (LMA) fiber can be used to reduce SBS and SRS to increase saturation power. However, the large mode area fiber when implemented will in turn cause a suppression of the peak power and leads to an undesirable results due to the reduction of the efficiency.

Therefore, a need still exists in the art of fiber laser design and manufacture to provide a new and improved configuration and method to provide fiber laser to enable the scale the power/energy of the laser source such that the above-discussed difficulty may be resolved.

### SUMMARY OF THE PRESENT INVENTION

It is therefore an object of the present invention to provide a method of using wavelength division multiplexing (WDM) technique to flexibly combine laser projections of different wavelengths to achieve energy/power scaling such that the above-discussed difficulties as that encountered in the prior art may be resolved.

It is another aspect of this invention that in order to further scale the power/energy of laser projections, the laser energy transmitted through lasers of different wavelengths may be combined. The fiber lasers projected into the WDM may have equal or unequal spectral spacing to scale the power from a couple of times, e.g., from two lasers, to tens or hundreds of times from multiple lasers.

It is a further aspect of this invention that the WDM are constructed and assembled with thin film technology using a glass substrate such that the WDM system may be provided with compact size without requiring alignment operations. The compact WDM may be conveniently implemented with the laser system to scale the laser energy/power.

Briefly, in a preferred embodiment, the present invention discloses a fiber laser system that includes a plurality of input ports for projecting a plurality of incident lasers each having a different wavelength to a wavelength divisional multiplexing (WDM) device for multiplexing a scaled portion for each of the incident lasers into a multiplexed and scaled output laser with a scaled output power. The fiber laser system further includes a collimator to collimate the plurality of incident lasers for projecting into the WDM device. An optical coupler optically coupled to the WDM device to combine the multiplexed output laser into an output laser with the scaled output power. In a preferred embodiment, the WDM device includes a grading WDM device for multiplexing and combining the plurality of incident lasers. In a preferred embodiment, the WDM device is disposed in a cavity of multiple lasers generating the plurality of incident lasers to the WDM device. In a preferred embodiment, the WDM device is disposed external to a plurality of laser cavities generating the plurality of incident lasers to the WDM device. In a preferred embodiment, the WDM device comprises a plurality of thin film filters for multiplexing a scaled portion of the plurality of incident lasers into a combined output laser with the scaled output power.

In a preferred embodiment, this invention further discloses a method for method for generating an output laser with a scalable output optical power from a fiber laser system. The method includes a step of projecting a plurality of incident lasers each having a different wavelength to a wavelength divisional multiplexing (WDM) device for multiplexing a scaled portion for each of the incident lasers into a multiplexed and scaled output laser with a scaled output power.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIG. 1 is a diagram for showing and comparing the extracted energy as a function of fiber length for one ns pulse from different amplifier/laser conditions.

FIG. 2 is schematic diagram for showing the working principle of wavelength multiplexing of multiple lasers.

FIG. 3 is a functional block diagram for showing an example of WDM in combining multiple lasers with different wavelengths.

FIGS. 4A to 4C are functional block diagrams for showing the processes of using WDM techniques of this invention for respectively A) externally combining; B) incorporating the fiber laser as part of the whole cavity; and C) incorporating part or the whole cavity in sharing one modulator for pulse operation.

FIG. 5 is a schematic drawing for showing a compact substrate mode WDM module of this invention.

FIGS. 6 to 7 is two schematic drawings for showing two alternate compact substrate mode WDM modules of this invention.

FIG. 8 is a diagram for showing the wavelength shift as a function of an incident angle.

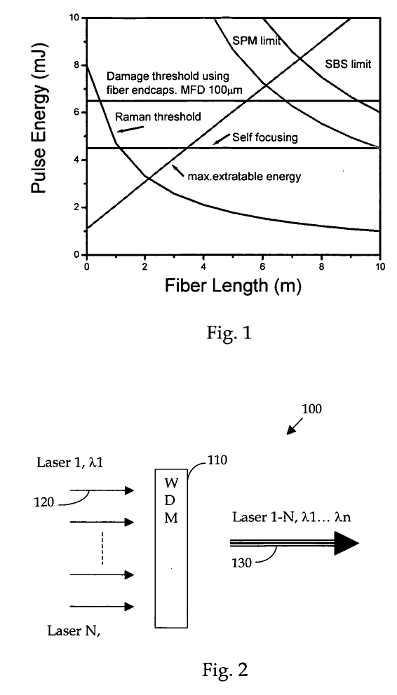

### DETAILED DESCRIPTION OF THE INVENTION

Referring to FIG. 2 for a schematic diagram of a fiber laser system 100 of this invention to further scale the power/energy of the laser system. The technique employed in the laser system 100 for scaling the power/energy is to implement a wavelength division-multiplexing (WDM) device 110 in the laser system. The WDM device 110 is employed to control the combinations of different portions of incident optical beams 120 each having a different wavelength to generate a multiplexed output optical beam 130 that can be scaled according to a combination of optical projection of different wavelength represented by λ1, λ2, λ3, . . . . λn. The WDM device 110 may be a multiplexing device as further described in FIGS. 5 to 7 below. As shown in FIG. 2, by applying a WDM technique, the energy/power from different fiber lasers 120 shown as λ1, λ2, λ3, . . . λn, with equal or unequal spectral spacing is coupled from a couple of times from two lasers to tens or hundred times to scale the energy/power. Specifically, FIG. 2 draws the schematic of the concept. The spectral spacing between two adjacent channels can be as narrow as tenth of nm and can be as large as a few nm, depending on application requirement.

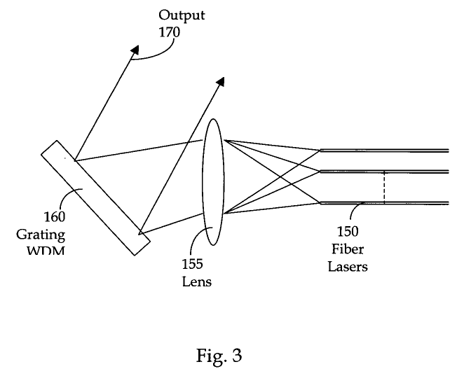

By using WDM technique, combinations of energy/power from different fiber lasers with equal or unequal spectral spacing by applying a grating WDM device 160 as shown in FIG. 3 to scale the power. The input lasers 150 projected through a lens 155 into the grating WDM device 160 to generate an output laser 170 with scalable power by employing the WDM technique.

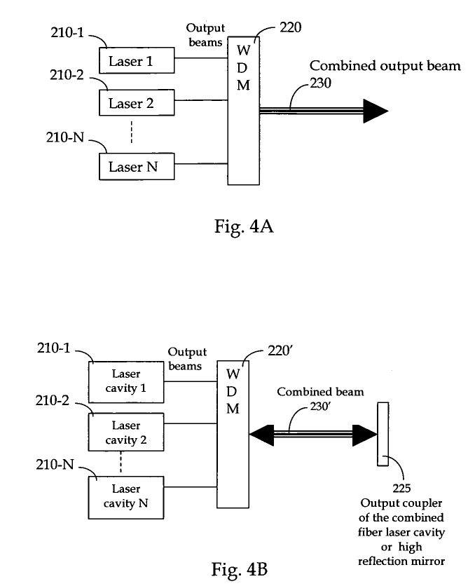

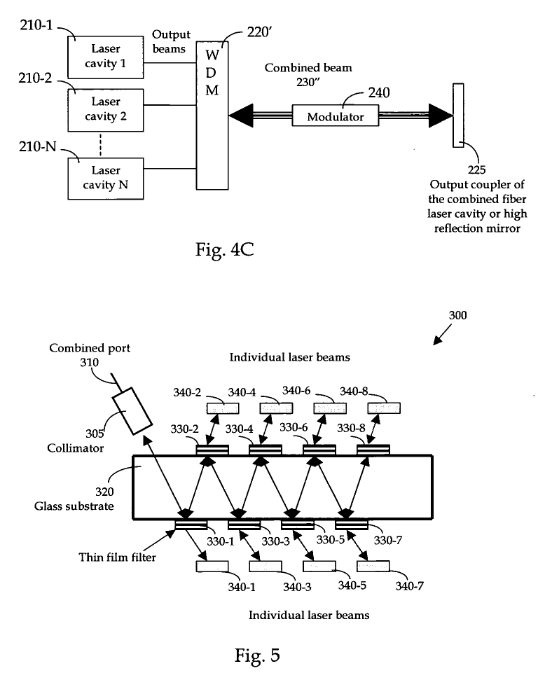

FIGS. 4A to 4C are three embodiments to show that the multiplexing of input lasers of multiple wavelengths through a WDM device that is incorporated as part of an external laser cavity. In FIG. 4A, multiple lasers lasing at various wavelengths 210-1, 210-2, . . . , 210-N are combined by using a WDM 220. This WDM 220 is not part of the cavity to generate a multiplexing output laser 230 with specifically scaled energy/power. In FIG. 4B, the WDM 220′ is incorporated as a part of the cavity with the output beam 230′ coupled and reflected from a mirror 225 with the WDM device 220′ and the mirror 240 constitute a cavity. FIG. 4B shows the multiple fiber lasers 210-1, 210-2, 210-3, . . . , 210-N share the output coupler by using the WDM. This eliminates the power limit of the fiber lasers and provides a compact solution as well. FIG. 4C is functional block diagram for another embodiment with the WDM 220′ incorporated as a part of a laser cavity that further includes a mirror and a pulse modulator 240 to provide a pulsed laser output 230 ″ for the fiber laser in scaling the energy. In both FIGS. 4B and 4C, the output coupler 225 can be a mirror reflecting all the lasing wavelengths back to WDM or other types of optical coupling device to interact with the WDM device 220′ to generate a laser output with scaled energy/power. Alternately, individual fiber laser input 210-1. 210-2, 210-3, . . . , 210-N may have its own output coupler to generate specific output. The scaling of the output may be flexibly adjusted according to a simple formula that the total output energy equals to the multiplexed energy transmitted through the optical signals in each wavelength. For example, if the multiplexed output signals are generated from the multiplexed optical signals transmitted over four wavelength channels, then the total energy may be adjusted through adjusting energy transmitted over four channels. Significant degrees of freedom are therefore available to scale the total output energy.

In order to more effectively scale an output power/energy of a fiber laser system, this invention further discloses an integrated solution to achieve a compact WDM module by using the thin film technology. FIG. 5 is a schematic diagram to illustrate a WDM of this invention. Referring to FIG. 5 for a WDM 300 receiving an incident optical beam 310 from a combined port (not shown) for projecting onto a collimator 305 and then into the WDM 300. The combined port may be a port of multiple channels to project an input optical beam 310 comprising multiple wavelengths. The WDM 300 is formed in a glass substrate 320 with the incident beam 310 projected into the WDM with a small angle such as 10 degrees. The surface of the glass substrate 320 is coated with an antireflection coating to reduce the reflection. The incident beam 310 is then projected through a thin film filter 330-1 to project onto an optical coupler 340-1 that may be an output port to coupled-in/out channels directly into each individual fiber laser usually with lens/collimator. As shown in FIG. 5, the thin film filters 330-1 to 330-8 are designed to transmit one lasing wavelength channel and reflect the rest of channels. Thin film filters 330-1 to 330-8 can be directly deposited on the glass substrate 320 or bond on the surface of the glass substrate 320 by epoxy, optical bonding, or other means in handling high power/energy operation. The individual lasers with specific wavelength transmitted through the thin film filters 330-1 to 330-8 are coupled and collimated to combined into an output beam with scalable total output energy/power.

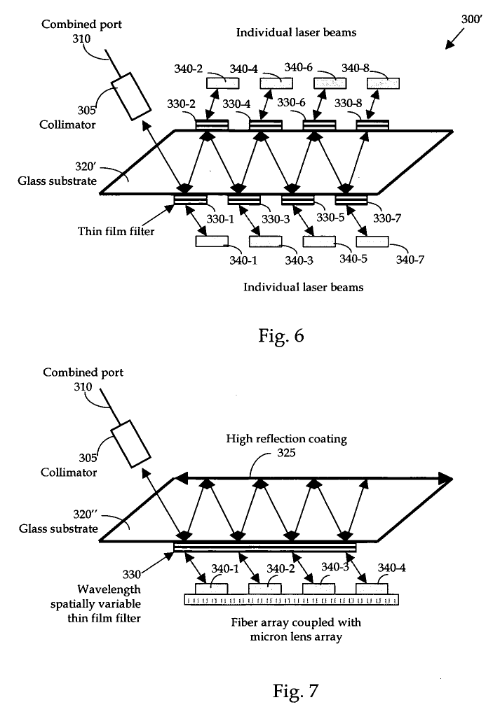

FIG. 6 is a schematic diagram to illustrate an alternate WDM of this invention. A WDM 300′ receiving an incident optical beam 310 from a combined port (not shown) for projecting onto a collimator 305 and then into the WDM 300′. The combined port may be a port of multiple channels to project an input optical beam 310 comprising multiple wavelengths. The WDM 300′ is formed in a wedged glass substrate 320′ where the wedged substrate 320′ is used to ease the light coupling. The incident beam 310 is projected into the WDM with a significantly larger angle related to the tilt edge of the substrate 320′. The surface of the glass substrate 320 is coated with an antireflection coating to reduce the reflection. The incident beam 310 is then projected through a thin film filter 330-1 to project onto an optical coupler 340-1 that may be an output port to coupled-in/out channels directly into each individual fiber laser usually with lens/collimator. As shown in FIG. 5, the thin film filters 330-1 to 330-8 are designed to transmit one lasing wavelength channel and reflect the rest of channels. Thin film filters 330-1 to 330-8 can be directly deposited on the glass substrate 320 or bond on the surface of the glass substrate 320 by epoxy, optical bonding, or other means in handling high power/energy operation. The individual lasers with specific wavelength transmitted through the thin film filters 330-1 to 330-8 are coupled and collimated to combined into an output beam with scalable total output energy/power.

FIG. 7 shows an alternate embodiment of this invention where the entire bottom surface of the glass substrate 320″ is coated with a thin layer of filtering thin film. The rate of the thin film deposition is controlled to provide a linear filter 330. At different locations on the bottom surface of the substrate 320″ transmissions of optical signals of different wavelengths are projected onto a corresponding optical coupler 340-1 to 340-4 with the top surface of the substrate 320 coated with a total reflective layer 325. A wedge filter 320″ as shown is commercially available through a Santer Company such as a linearly tunable filter OTM-30M. The fiber coupler array that includes spatially separated couplers 340-1 to 340-4 located at different locations to receive the optical signals in different wavelength channels. The optical coupler array 340-1 to 340-2 are disposed on a fiber array with micro lenses to couple and transmit and combine the output signals from the WDM system. This configuration further provides an advantage of reducing the package size. Another option is to substitute the fiber array 350 with a photodiode array to couple and combine the output signals into flexibly scalable output signals.

According to above descriptions and drawings, this invention discloses a fiber laser system for generating an output laser with a scalable output optical power. The fiber laser system includes an input port for projecting an incident laser includes lasers of different wavelengths. The fiber system further includes a WDM device for demultiplexing the incident beam into a plurality of demultiplexed lasers each having a different wavelength for scaling and combining the demultiplexed lasers into an output laser with a scaled output power. In a preferred embodiment, the WDM device further includes a plurality of thin film filters for demultiplexing the incident beam by transmitting a laser of a bandpass wavelength through the thin film filters and reflecting a laser for wavelengths different from the bandpass wavelength. In a preferred embodiment, the WDM device further includes a plurality of thin film filters disposed on a glass substrate for demultiplexing the incident beam by transmitting a laser of a filter-specific bandpass wavelength through each of the thin film filters and reflecting a reflected laser with wavelengths different from the filter-specific bandpass wavelength wherein the reflected laser are reflected to another thin film filter for transmitting and reflecting for demultiplexing the laser into the plurality of demultiplexed lasers. In a preferred embodiment, the glass substrate includes a wedge shaped glass substrate for easing an optical coupling of the incident beam into the glass substrate. In a preferred embodiment, the fiber laser system further includes an output laser coupler for coupling and combining the demultiplexed output lasers into a combined output laser with the scaled output power. In a preferred embodiment, the WDM device further includes a thin film filter configured as a thin layer covering an entire surface of a surface of the glass substrate having different filtering characteristics over different locations of the thin film filter and the glass substrate further having an opposite surface covering with a high reflectivity layer wherein the thin film filter demultiplexing the incident beam by transmitting a laser of a bandpass wavelength through the thin film filter and reflecting a reflected laser for wavelengths different from the bandpass wavelength to the opposite surface coated with the high reflectivity layer for reflecting back to the thin film filter for further demultiplexing the reflected laser. In a preferred embodiment, the fiber laser system further includes a plurality of optical couplers disposed below the thin film filter for coupling the demultiplexed laser with the bandpass wavelength to a fiber array coupled to the optical couplers with a micro-lens array.

In an alternate embodiment, the laser system further includes an amplifier gain medium having a double cladding Ytterbium-doped Photonics crystal fiber (DC YDPCF) for amplifying an optical signal transmitted in the laser system. In an alternate embodiment, the laser system further includes an amplifier gain medium having a double cladding Photonics crystal fiber (DC PCF) for amplifying an optical signal transmitted in the laser system. In another embodiment, the laser system further includes an amplifier gain medium having a double cladding Ytterbium (Yb) doped fiber (DC YDF) for amplifying an optical signal transmitted in the laser system. In another embodiment, the laser system further includes an amplifier gain medium includes a large mode area (LMA) fiber. The gain mediums implemented with large mode area (LMA) fibers, DC YDPCF, DC PCF, and DC YDF have been disclosed in three other pending patent applications Ser. No. 10/825,746, 11/136,040, and 11/386,240 submitted by the Applicant of this invention. The disclosures made in the applications Ser. No. 10/825,746, 11/136,040, and 11/386,240 are hereby incorporated by reference.

According the descriptions for FIGS. 5 to 7, this invention discloses a wavelength division multiplexing (WDM) device. The WDM device includes a plurality of thin film filters disposed on a glass substrate for demultiplexing an incident beam by transmitting a laser of a filter-specific bandpass wavelength through each of the thin film filters and reflecting a reflected laser with wavelengths different from the filter-specific bandpass wavelength wherein the reflected laser are reflected to another thin film filter for transmitting and reflecting for demultiplexing the laser into the plurality of demultiplexed lasers. In a preferred embodiment, the glass substrate comprising a wedge shaped glass substrate for easing an optical coupling of the incident beam into the glass substrate. In another preferred embodiment, the WDM device further includes an output laser coupler for coupling and combining the demultiplexed output lasers into a combined output laser with a scaled output power. In another preferred embodiment, the WDM device further comprising a thin film filter configured as a thin layer covering an entire surface of a surface of the glass substrate having different filtering characteristics over different locations of the thin film filter and the glass substrate further having an opposite surface covering with a high reflectivity layer wherein the thin film filter demultiplexing the incident beam by transmitting a laser of a bandpass wavelength through the thin film filter and reflecting a reflected laser for wavelengths different from the bandpass wavelength to the opposite surface coated with the high reflectivity layer for reflecting back to the thin film filter for further demultiplexing the reflected laser. In another preferred embodiment, the WDM device further includes a plurality of optical couplers disposed below the thin film filter for coupling the demultiplexed laser with the bandpass wavelength to a fiber array coupled to the optical couplers with a micro-lens array.

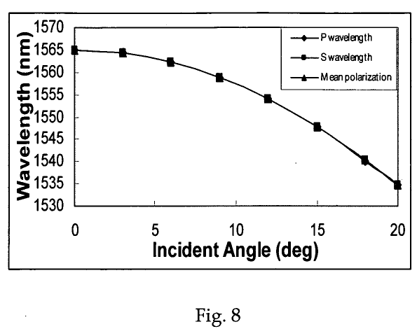

Assuming that the thickness of the substrate 320 is d and the angle of incidence for thin film filter is θ. The beam size is c and the distance between two adjacent filters is t. From geometrical theory, the distance between two adjacent filters t is calculated as 2d tan θ. The center wavelength of the filters will shifted according to the angle of incidence as shown in FIG. 8. In the WDM applications, the angle of incidence has to be selected to assure that the shifted wavelength still fall within the range of the lasing wavelengths. For example, in a glass substrate 320 shown in FIG. 5, when the incident angle θ=10°, and t=5 mm, then d=14 mm. Alternately, in a wedge substrate 320′ of FIG. 6, when the incident angle θ is 10°, and t=0.5 mm, then d=1.4 mm.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

I claim:

1. A fiber laser system for generating an output laser with a scalable output optical power comprising:
a plurality of input ports for projecting a plurality of incident lasers each having a different wavelength to a wavelength divisional multiplexing (WDM) device for multiplexing a scaled portion for each of said incident lasers into a multiplexed and scaled output laser with a scaled output power.

2. The fiber laser system of claim 1 further comprising:
a collimator to collimate said plurality of incident lasers for projecting into said WDM device.

3. The fiber laser system of claim 1 further comprising:
an optical coupler for optically coupling to said WDM device for combining said multiplexed output laser into an output laser with said scaled output power.

4. The fiber laser system of claim 1 wherein:
said WDM device comprises a grading WDM device for multiplexing and combining said plurality of incident lasers.

5. The fiber laser system of claim 1 wherein:
said WDM device is disposed in a cavity of multiple lasers generating said plurality of incident lasers to said WDM device.

6. The fiber laser system of claim 1 wherein:
said WDM device is disposed external to a plurality of laser cavities generating said plurality of incident lasers to said WDM device.

7. The fiber laser system of claim 1 wherein:
said WDM device comprises a plurality of thin film filters for multiplexing a scaled portion of said plurality of incident lasers into a combined output laser with said scaled output power.

8. The fiber laser system of claim 1 further comprising:
an input port for projecting said plurality of incident lasers as a incident beam comprising lasers of different wavelengths; and
said WDM device further demultiplexing said incident beam into a plurality of demultiplexed lasers each having a different wavelength for scaling and combining into an output laser with said scaled output power.

9. The fiber laser system of claim 8 wherein:
said WDM device further comprising a plurality of thin film filters for demultiplexing said incident beam by transmitting a laser of a bandpass wavelength through said thin film filters and reflecting a laser for wavelengths different from said bandpass wavelength.

10. The fiber laser system of claim 8 wherein:
said WDM device further comprising a plurality of thin film filters disposed on a glass substrate for demultiplexing said incident beam by transmitting a laser of a filter-specific bandpass wavelength through each of said thin film filters and reflecting a reflected laser with wavelengths different from said filter-specific bandpass wavelength wherein said reflected laser are reflected to another thin film filter for transmitting and reflecting for demultiplexing said laser into said plurality of demultiplexed lasers.

11. The fiber laser system of claim 11 wherein:
said glass substrate comprising a wedge shaped glass substrate for easing an optical coupling of said incident beam into said glass substrate.

12. The fiber laser system of claim 8 further comprising:
an output laser coupler for coupling and combining said demultiplexed output lasers into a combined output laser with said scaled output power.

13. The fiber laser system of claim 8 wherein:
said WDM device further comprising a thin film filter configured as a thin layer covering an entire surface of a surface of said glass substrate having different filtering characteristics over different locations of said thin film filter and said glass substrate further having an opposite surface covering with a high reflectivity layer wherein said thin film filter demultiplexing said incident beam by transmitting a laser of a bandpass wavelength through said thin film filter and reflecting a reflected laser for wavelengths different from said bandpass wavelength to said opposite surface coated with said high reflectivity layer for reflecting back to said thin film filter for further demultiplexing said reflected laser.

14. The fiber laser system of claim 13 further comprising:
a plurality of optical couplers disposed below said thin film filter for coupling said demultiplexed laser with said bandpass wavelength to a fiber array coupled to said optical couplers with a micro-lens array.

15. The fiber laser system of claim 1 further comprising:
an amplifier gain medium having a double cladding Ytterbium-doped Photonics crystal fiber (DC YDPCF) for amplifying an optical signal transmitted in the fiber laser system.

16. The fiber laser system of claim 1 further comprising:
an amplifier gain medium having a double cladding Photonics crystal fiber (DC PCF) for amplifying an optical signal transmitted in the fiber laser system.

17. The fiber laser system of claim 1 further comprising:
an amplifier gain medium having a double cladding Ytterbium (Yb) doped fiber (DC YDF) for amplifying an optical signal transmitted in the fiber laser system.

18. The fiber laser system of claim 1 further comprising:
an amplifier gain medium having a large mode area (LMA) fiber.

19. A fiber laser system for generating an output laser with a scalable output optical power comprising:
an input port for projecting an incident laser comprising lasers of different wavelengths; and
a WDM device for demultiplexing said incident beam into a plurality of demultiplexed lasers each having a different wavelength for scaling and combining said demultiplexed lasers into an output laser with a scaled output power.

20. The fiber laser system of claim 19 wherein:
said WDM device further comprising a plurality of thin film filters for demultiplexing said incident beam by transmitting a laser of a bandpass wavelength through said thin film filters and reflecting a laser for wavelengths different from said bandpass wavelength.

21. The fiber laser system of claim 19 wherein:
said WDM device further comprising a plurality of thin film filters disposed on a glass substrate for demultiplexing said incident beam by transmitting a laser of a filter-specific bandpass wavelength through each of said thin film filters and reflecting a reflected laser with wavelengths different from said filter-specific bandpass wavelength wherein said reflected laser are reflected to another thin film filter for transmitting and reflecting for demultiplexing said laser into said plurality of demultiplexed lasers.

22. The fiber laser system of claim 19 wherein:
said glass substrate comprising a wedge shaped glass substrate for easing an optical coupling of said incident beam into said glass substrate.

23. The fiber laser system of claim 19 further comprising:
an output laser coupler for coupling and combining said demultiplexed output lasers into a combined output laser with said scaled output power.

24. The fiber laser system of claim 19 wherein:
said WDM device further comprising a thin film filter configured as a thin layer covering an entire surface of a surface of said glass substrate having different filtering characteristics over different locations of said thin film filter and said glass substrate further having an opposite surface covering with a high reflectivity layer wherein said thin film filter demultiplexing said incident beam by transmitting a laser of a bandpass wavelength through said thin film filter and reflecting a reflected laser for wavelengths different from said bandpass wavelength to said opposite surface coated with said high reflectivity layer for reflecting back to said thin film filter for further demultiplexing said reflected laser.

25. The fiber laser system of claim 19 further comprising:
a plurality of optical couplers disposed below said thin film filter for coupling said demultiplexed laser with said bandpass wavelength to a fiber array coupled to said optical couplers with a micro-lens array.

26. A method for generating an output laser with a scalable output optical power from a fiber laser system comprising:
projecting a plurality of incident lasers each having a different wavelength to a wavelength divisional multiplexing (WDM) device for multiplexing a scaled portion for each of said incident lasers into a multiplexed and scaled output laser with a scaled output power.

27. A wavelength division multiplexing (WDM) device:
a plurality of thin film filters disposed on a glass substrate for demultiplexing an incident beam by transmitting a laser of a filter-specific bandpass wavelength through each of said thin film filters and reflecting a reflected laser with wavelengths different from said filter-specific bandpass wavelength wherein said reflected laser are reflected to another thin film filter for transmitting and reflecting for demultiplexing said laser into said plurality of demultiplexed lasers.

28. The WDM of claim 27 wherein:
said glass substrate comprising a wedge shaped glass substrate for easing an optical coupling of said incident beam into said glass substrate.

29. The WDM of claim 27 further comprising:
an output laser coupler for coupling and combining said demultiplexed output lasers into a combined output laser with a scaled output power.

30. The WDM of claim 27 wherein:
said WDM device further comprising a thin film filter configured as a thin layer covering an entire surface of a surface of said glass substrate having different filtering characteristics over different locations of said thin film filter and said glass substrate further having an opposite surface covering with a high reflectivity layer wherein said thin film filter demultiplexing said incident beam by transmitting a laser of a bandpass wavelength through said thin film filter and reflecting a reflected laser for wavelengths different from said bandpass wavelength to said opposite surface coated with said high reflectivity layer for reflecting back to said thin film filter for further demultiplexing said reflected laser.

31. The WDM of claim 27 further comprising:
a plurality of optical couplers disposed below said thin film filter for coupling said demultiplexed laser with said bandpass wavelength to a fiber array coupled to said optical couplers with a micro-lens array.
